(19) United States
(12) Patent Application Publication
(10) Pub. No.: US 2003/0101204 A1
(43) Pub. Date: May 29, 2003

(54) Method for converting units of measurement

(76) Inventor: Todd E. Watson, West Warwick, RI (US)

Correspondence Address: Todd E. Watson, 123 Prospect Hill Avenue, West Warwick, RI, 02893, US

(21) Appl. No.: 09/816,281

(22) Filed: Mar. 24, 2001

(51) Int. Cl. G06F 7/00

(52) U.S. Cl. 708/206

(57) ABSTRACT

A method for performing unit conversions. The method employs a calculating device comprised of an alphanumeric keypad and a display device. Required inputs include a numeric value, or an expression that can be evaluated as a numeric value, representing the quantity of the unit string to be converted from, an undesired unit string and a desired unit string. Each unit string can consist of a single unit or a plurality of units joined by arithmetic symbols. Units are entered by typing the full spelling of the unit name or the spelling of an alias name on an alphanumeric keypad. The method segregates the unit string into its component parts, specifically, unit names, positive and negative exponents, multiplication and division. Each numerator and denominator undesired unit is respectively converted to a numerator and denominator desired unit. All derived units which can not be converted are replaced with their equated unit string comprised of two or more other units which may be base units or other derived units. The conversion process continues until all numerator and denominator units are converted, or until there are no more derived units to substitute other units for. If all units are successfully converted, the conversion factors used in the conversion process are multiplied together and multiplied by the numeric input value. The result is then displayed.

### FEDERALLY SPONSORED RESEARCH

Not applicable

### CROSS-REFERENCE TO RELATED APPLICATIONS

Not applicable

### SEQUENCE LISTING OR PROGRAM LISTING

Not applicable

### BACKGROUND

1. Field of Invention

This invention relates to a method for converting units of measure within any given system of units or from one system of units to another.

2. Description of Prior Art

Global developments in commerce and communication which have proliferated since the second World War, have spawned the intense need for those dealing with measures of any kind to communicate using a common basis of measure. By way of example, there are currently seven version of the “Horsepower”, eight versions of the “British Thermal Unit”, fourteen versions of the “atomic mass unit” and nine versions of the “barrel”, to name a few. To further confuse matters, the various derivations of each of these and other units are often used in the same country. Because of its simplicity, the SI (Systems International) has been adopted by most countries as the standard unit system.

For the United States of America, the changeover to the SI system has been a slow one. Even for other countries which adopted the SI System long before the United States, many native units are still used on a common basis. There is therefore a need to convert between units of like measure both within and outside of any given system of units.

Many references exist that address the conversion of units. Consider the following prior art references in the form of unit conversion software:

Measure 2.5 by George Lewe

Conversion 2.0 by Pokluda

Reconverter 1.0 by Rolland A. Ceniza

Universal Converter 1.0 by Noël Danjou

Meracl MultiConverter 1.0 by Meracl Software

HiMetric 1.3 by fCoder Group International

OmniCon98 by Phillip M. G. Jones

UnitConverter 1.01 by Salony Software

ESB Unit Conversion Utility by ESB Consultancy

Converse 1.3 by Jiri Polasek

Convert and Calculate 2.0 by Thomas Hawkins

Tek Unit Converter 3.01 by Tek Design

Unit Conversion Utiltiy 1.0.15 by Jim Willsher

Unit Converter 1.01 by Johannes Wallroth

Unit Converter 1.0 by HB Team

Universal Conversion Calculator by John Miskimins

Measurement Converter 1.0 by V&T Software

Conversions for Windows by Dutch's Software

MCC 1.0 by Lee Tanner

Win Convert 5.2 by Derrick Powell

Sicyon 1.7 by Teodor Krastev

WinUnit 3.1 by Engineering Software Services Ltd.

ConvertIt! by CSI

Each of these applications along with a myriad of websites that allow unit conversions to be conducted online, share the same technique for identifying units. The category of measure must first be determined, such as length, mass, velocity and the like, before the units within that category are located. One limitation to this method of selecting units is that unless the User knows the particular category that a unit belongs, he has either no way of finding the unit, or for at least one of the prior art sources listed, must involve the extra step of searching the database for the unit before selecting the category and subsequently, the unit. For example, the aforementioned prior art, Unit Conversion Utility, displays units relating to radiation under the category “Absorbed Dose”. Whereas, the prior art reference WinUnit refers to such units as “Radiation Dose”. Another example is the category of “Magnetomotive Force” displaying the unit “Ampere” (OmniCon 98), whereas WinUnit displays “Ampere” under the category “Current”. Clearly, given the somewhat nebulous categorical designations for units, locating a unit can be a rather laborious task.

Another limitation of unit categories is having to list units from which to pick. For many categories, the list of units, if exhaustive, can be quite extensive, especially if the unit category relates to a derived unit (comprised of more than one other unit). For such a category, a conversion factor for every unit representing a subcategory must be provided. For example, consider the conversion of the derived unit “Watt” to its multi-unit equivalent, that is, a unit of energy divided by a base unit of time. Most references will provide “Joule/second” or perhaps “foot pound/minute” since these are common combinations of units. However, the unit equivalent of “angstroms/nanosecond”, will most certainly not be provided, and if it were provided, along with the hundreds of other possible combinations, the process of scanning the tabulation would be daunting, at best. Consequently, there is a need for the aforementioned method of conversion, to provide only the most probable conversion possibilities and in doing so, leave out many other possibilities. Indeed, this is the case with all forms of software prior art previously mentioned.

Yet another limitation of unit categories is that if a category for a particular combination of units does not exist, conversion of units within that category must be done incrementally and manually. Consider the conversion of volumetric flow rate, namely, a unit a volume divided by a unit of time. For many of the prior art software titles mentioned, a “Volumetric Flow Rate” category does not exist. In fact, no “Flow Rate” categories exist. As such, the conversion must be performed incrementally by first converting the unit of volume, then converting the unit of time and manually dividing the two factors to yield the result.

Consider now the next sources of prior art in the form of the following United States Patents: U.S. Pat. No. 5,371,694 (1994), U.S. Pat. No. 5,216,627 (1993), U.S. Pat. No. 5,101,368 (1992), U.S. Pat. No. 5,079,732 (1992), U.S. Pat. No. 4,686,643 (1987), U.S. Pat. No. 4,228,516 (1980), and U.S. Pat. No. 4,092,523 (1978) all utilize unit categories and are subject to the limitations previously mentioned. In addition, each of these inventions along with all of the prior art software titles previously mentioned as well as United States Patents U.S. Pat. No. 4,881,189 (1989), U.S. Pat. No. 4,744,044 (1988), U.S. Pat. No. 4,458,325 (1984), U.S. Pat. No. 4,319,130 (1982), U.S. Pat. No. 4,290,113 (1981) and U.S. Pat. No. 4,001,569 (1977) utilize one of two conversion methods. The first method uses a single conversion factor to convert the undesirable unit into the desirable unit. The second method utilizes two conversion factors. The first converts the undesirable unit into a common unit, also called a pivot unit, and then applies another conversion factor to convert the pivot unit into the desirable unit. Publications which tabulate unit conversion factors are typically written in both manners. The limitation of either conversion method is as previously mentioned. In converting a derived unit to its multi-unit equivalents, there must exist at least one conversion factor for each and every possible combination of units.

### SUMMARY

An object of the present invention is to provide an improved method for converting units which overcomes the limitations of prior methods, specifically, by offering the following advantages:

The User enters units by either typing in the full spelling of the unit name or by entering a common abbreviation or alias name. Unlike certain prior art, the User does not need to have knowledge of the specific category in which a unit belongs. Additionally, the user need not scroll through a list of units within the specific category in order to select the desired unit to be used in the conversion process.

The present invention allows for the conversion between two strings of units each consisting of a plurality of units separated by arithmetic symbols. The method of the present invention separates each string into constituent parts, namely, the units, the mathematical symbols and any exponentiation applied to the units. The conversion process is then conducted between each individual unit. The individual conversion factors are multiplied or divided and raised to any exponential power, depending on the arithmetic symbols used in each unit string. By combining individual units mathematically, thousands of possible unit combinations need not be entered into the tabulation of unit conversion factors. The conversion process executes faster and the tabulation of conversion factors is generated with greater accuracy as there is less of a chance that viable conversion factors will be overlooked or that conversion factors will be entered incorrectly.

The present invention prompts the User to select the desired version of multi-version units. Thus, the User need not have to type long multi-definition unit names such as “Mechanical Horsepower”. “Horsepower” or simply “hp” will result in the method prompting the User to pick the intended version from a list of, in this case, six choices: mechanical, boiler, electric, water, metric and brake. When one of the versions is selected, an explanation fo the unit appears assisting the User in determining if the selected version is appropriate. Additionally, once the unit is chosen, the User has the option of saving the particular version to a file and or to memory for reference when conversions are sought without interrogation.

The present invention is not limited to a one unit or two unit conversion process as any unsuccessfully converted derived unit will be replaced with its multi-unit equivalent and the conversion process will be automatically reinitiated. A multi-unit equivalent is comprised of one or more base units and or other derived units. The replacement process continues until all units are successfully converted or until all derived units have been replaced with their base unit equivalents and any System International (SI) prefixes have been removed from each of the units. Base unit equivalents are comprised of fundamental SI base units for time, length, amount of substance, mass, luminous intensity, temperature, and electrical current. The replacement process which is part of the method of the present invention, allows the use of many factors contained in a tabulated source of factors to be used to generate a single conversion factor. The present invention, therefore, allows a greater number of conversions to be carried out while utilizing a source containing fewer tabulated factors than the prior art previously discussed.

Further objects and advantages of the present invention will become apparent from a consideration of the drawings and ensuing description.

### DESCRIPTION OF DRAWINGS

FIG. 1 depicts boxes 1 through 25 of a flowchart relating to the first three steps of the unit conversion method.

FIG. 2 depicts boxes 26 through 48 of a flowchart relating to specific steps involved in the conversion process.

FIG. 3 depicts a partial listing of the Units Table within the Units Database. Field names are displayed across the top of the table.

FIG. 4 depicts a partial listing of the Derived Table within the Units Database. Field names are displayed across the top of the table.

### DETAILED DESCRIPTION

Preferred Embodiment—

The present invention is specifically tailored to a calculating device such as a desk-top calculator, hand-held calculator, desk top computer, lap top computer, palm computer and the like, that can be programmed, either through hardware or software, to carry out the steps of the following description.

Operation—

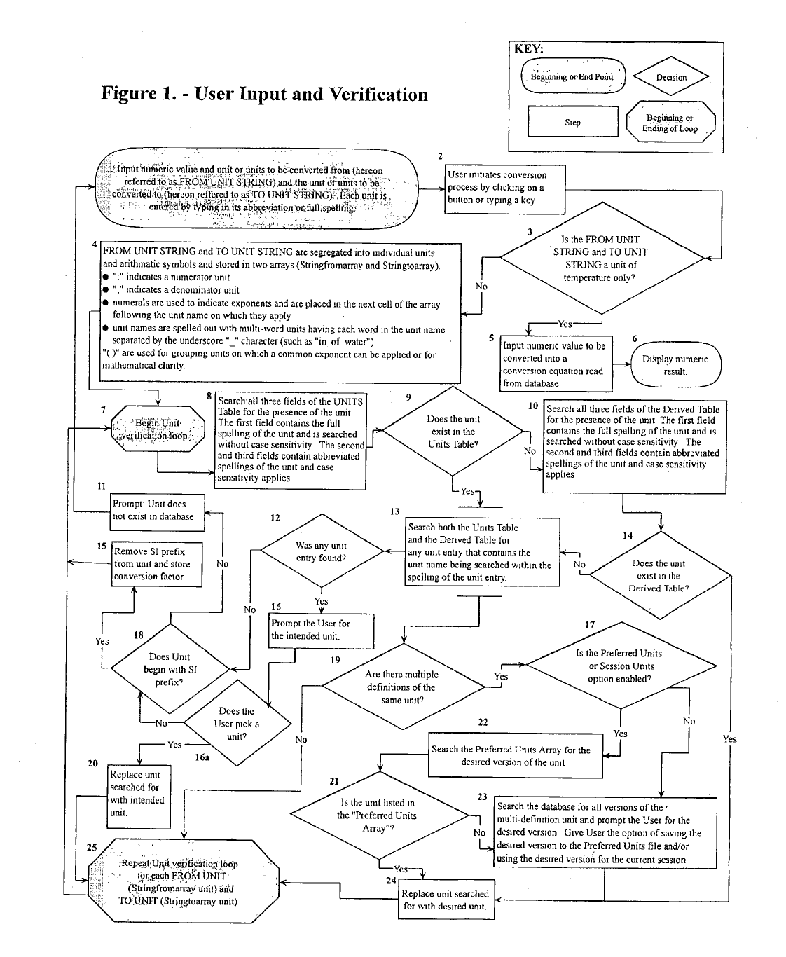

Referring now to FIG. 1, Beginning Point 1 describes the first step of the conversion process—Input. A numeric value or an equation that can be evaluated to a numeric value, indicating the scalar quantity of the unit or plurality of units to be converted from is entered. Next, the User inputs the singular unit, or plurality of units separated by arithmetic symbols, to be converted from, hereafter referred to as the From Unit String. Lastly, the User inputs the singular unit, or plurality of units separated by arithmetic symbols, to be converted to, hereafter referred to as the To Unit String. If a plurality of units is entered, each unit may be separated by an asterisk, “*”, indicating multiplication, a blank space also indicating multiplication, a forward slash, “/”, indicating division, or parenthesis indicating grouping or numerator or denominator placement. Additionally, each unit or closing parenthesis may be followed by a carrot, “ˆ ”, and a positive or negative number indicating exponentiation. In entering the From Unit String or To Unit String, the User types the alphabetic characters representing the full spelling of the unit name or its abbreviation.

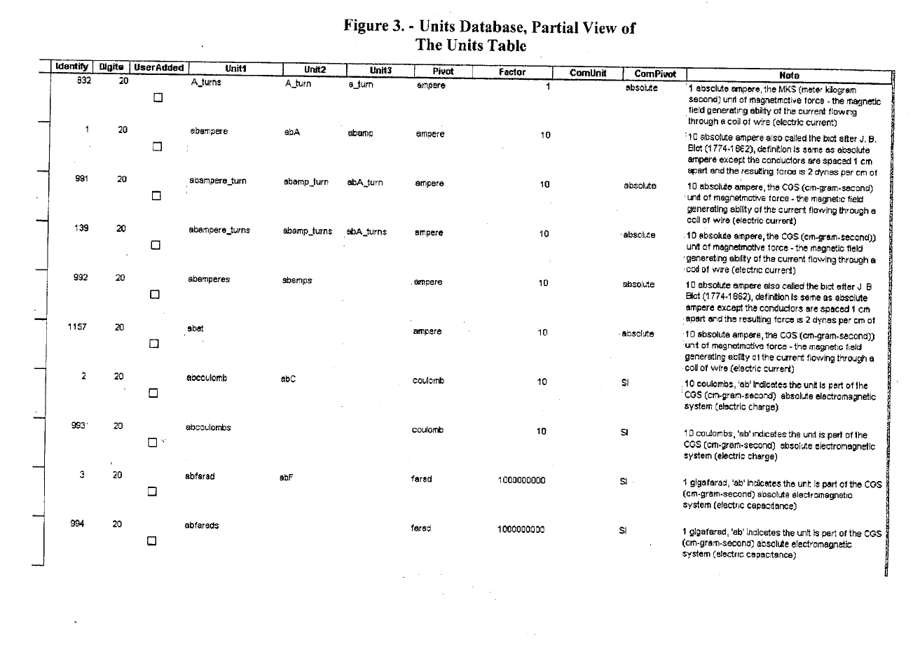

The database from which the method locates each unit and its associated conversion factor and which is structured according to and as part of the present invention, may have an unlimited number of optional spellings for each unit, thereby increasing the method's probability of finding each unit to be converted in the database. The database is comprised of two tables of data. The Units Table contains one entry for any unit in a given category that can be equated to another unit in the same category, called a pivot unit, see FIG. 3. The Derived Table contains an entry for every pivot unit that is also a derived unit, meaning a unit that can be expressed in terms of two or more other derived units or base units. The Derived Table also contains an entry for every derived unit for which there is no other unit in the same category.

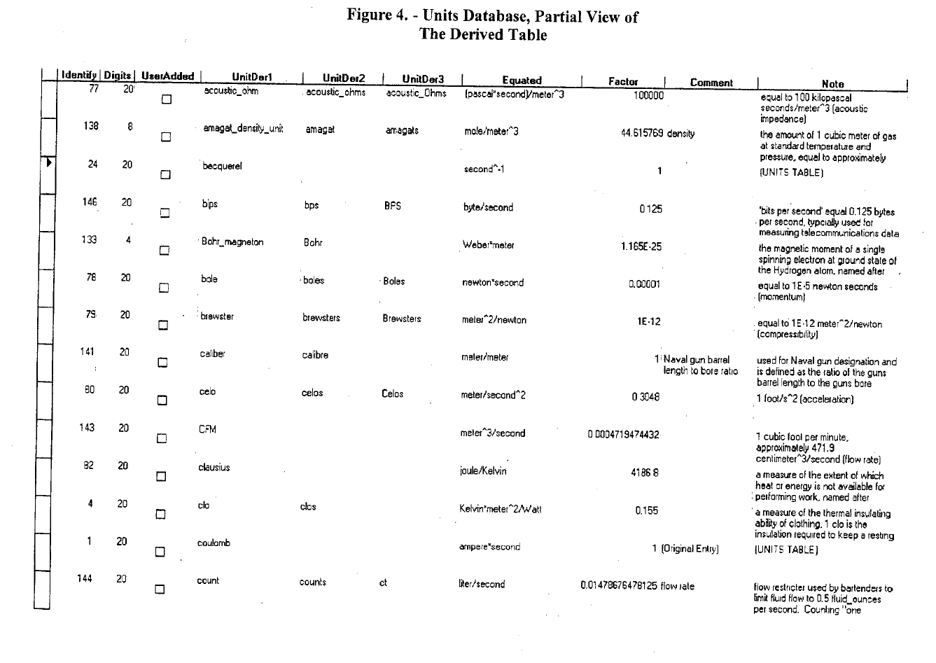

For each unit entry in either the Units Table or the Derived Table, three fields are devoted for the identification of the unit name. Referring to FIGS. 3 and 4, these fields are titled Unit1, Unit2 and Unit3 in the Units Table and UnitDer1, UnitDer2 and UnitDer3 in the Derived Table. These field names, as well as other database field names, are arbitrary and are not intended to limit the present invention. The first unit name fields, Unit1 and UnitDer1, contain the full spelling of the unit. When these fields are searched by the method described herein, case sensitivity is not applied. Meaning, the method looks for the presents of the characters with no regard to capitalization. The other four fields, Unit2, Unit3, UnitDer2 and UnitDer3, contain alias names that may be used in identifying the unit. Case sensitivity is applied by the method when searching these four fields since many units share the same abbreviation but vary according to case. For example, second is abbreviated with a lowercase “s”, whereas Siemens is abbreviated with a capital “S”.

Continuing now with FIG. 1, Step 2, the User initiates the conversion process by clicking a button or hitting a key. In Decision 3 of FIG. 1, the method compares the From Unit String and To Unit String with the following strings: degree Fahrenheit, deg_Fahrenheit, degree_F, deg_F, degree_Celsius, deg_Celsius, degree_C, deg_C, degree_Rankine, deg_Rankine, degree_R, deg_R, Kelvin, and K. If both the From Unit String and To Unit String match any of these temperature strings, the numeric value to be converted from is inputted into the appropriate equation according to Step 5 and the result is displayed as output, Step 6.

Results are displayed according to preferences set on the Setup Form. The Setup Form is comprised of several options that relate to how the result is displayed as well as how many digits are reported. Display options relate to the number of significant digits displayed and the format in which the number is displayed. The User may pick one of three available options which determine the number of significant digits that the result is displayed in. The User may pick from one to the maximum number allowed by the conversion factors used in the conversion process. Another option is to display the result using the maximum number of digits allowed by the conversion factors. The last option is to display the result with the same number of significant digits as the number to be converted from, up to the maximum allowed by the conversion factors. The maximum number of figures is determined by the methods ability to read the digits field in the recordset for each unit and using the lowest number as the maximum number of significant digits to report the result in. In regards to the format of the result, the User may pick exponential notation or floating point decimal. The User may also set high and low threshold values which will force the result to be displayed in exponential notation if the result is less than the low value or greater than the high value. One more display option allows the result to be displayed with a space between every third digit, called triad delineation.

Continuing with FIG. 1, Decision 3, if neither the From Unit String or To Unit String match the temperature strings, the method segregates the From Unit String and To Unit String into their individual units, arithmetic symbols and exponential values, according to Step 4. The method then generates two arrays, StringFromArray and StringToArray, to hold the From Unit String and To Unit String components according to the following example:

| | |
|---|---|
| From Unit String = “grains/(hour ft\hat{ }2 inHg)” | To Unit String = “perm” |
| : | : |
| grains | perm |
| ; | StringToArray |
| hour | |
| ; | |
| ft | |
| +2 | |
| ; | |
| inHg | |
| StringFromArray | |

The symbol “:” before a unit indicates the following unit occurs in the numerator. Likewise, the symbol “;” before a unit indicates that the following unit occurs in the denominator. A number that follows a unit indicates that the previous unit is raised to that power.

Referring to Step 8 of FIG. 1, the method begins searching the database to ensure that all units to be converted can be found in Units Table of the database. If not, the method will direct the search to the Derived table, as indicated by Question 9. If the unit is found in the Units Table, the method reads the contents of the ComUnit Field as indicated in FIG. 3. If this field is not blank, there are multiple definitions fo the same unit, Decision 19. Decision 17 of FIG. 1 then checks the value of the UsePreferredUnits and UseSessionUnits variables to determine if the User wishes to use preferred units—desired versions of multi-definition units that have been previously chosen and saved to a file for later reference or session units—desired versions of multi-definition units that have been previously chosen within the current session. If either the UsePreferredUnits variable or the UseSessionUnits variable is true, the current unit to be converted is searched for in the PreferredUnitsArray, Step 22. Referring to Question 21, if a version of the current unit to be converted is found, its information is read from the PreferredUnitsArray and written into its existing location in the StringFromArray or StringToArray, as indicated in step 24. The unit information stored in the StringFromArray or StringToArray is the unit bookmark (locates the recordset in which the unit was found), field name (indicates the database field where the unit was found) and the notes (explains the version of a multi-definition unit).

If the UsePreferredUnits variable and the UseSessionUnits variables are false, the method will search the Units Table and the Derived Table for all version of the current unit, Step 23. The User will be prompted for which version to use in the conversion process. Once chosen, the units information (bookmark, field and note) is read from whatever table the unit was found and written into its existing location in the StringFromArray or StringToArray, as indicated in step 24.

Referring back to Step 10 of FIG. 1, if the unit is not found in the Units Table, the method will continue searching for the unit in the Derived Table. If the unit does exist in the Derived Table, Question 14, the method reads the bookmark value, field name, and notes from the Derived Table and writes it into the units position in the StringFromArray or StringToArray, Step 24. The process continues for each remaining unit in the StringFromArray and StringToArray, End Point 25 of FIG. 1.

Referring back to Question 14 of FIG. 1, if the unit can not be found in either the Units Table or the Derived Table, the method will conduct a search of both tables for any unit entry that is a close match to the unit being searched for, Step 13 of FIG. 1. If at least one entry exists, the method will prompt the User with the results of the partial match search, Step 16. If the User chooses one of the entries, Step 16a, the method will read the bookmark value, field name, and notes from the table in which the unit was found and write it into the units position in the StringFromArray or StringToArray, Step 20. If the User does not pick one of the entries from the results of the partial match search, the method will determine if the unit begins with an SI prefix, Question 18.

The method determines if the unit begins with an Si prefix by comparing the following prefix strings with the beginning characters of the unit:

| | | | | | | | | | | |
|---|---|---|---|---|---|---|---|---|---|---|
| deci | d | centi | c | milli | m | micro | nano | n | pico | p |
| femto | f | atto | a | zepto | z | yocto | | y | | |
| deka | da | hecta | h | kilo | k | mega | | M | giga | G |
| tera | T | peta | P | exa | X | zetta | | Z | yotta | Y |

If the unit begins with any of aforementioned prefix strings, the string is removed from the unit. The conversion factor required to convert the prefixed unit to the unprefixed unit is stored in the Conversion Array, Step 15, and the method begins the verification loop, Step 7, with the unprefixed unit. If the unit does not begin with an SI prefix string, the method prompts the User that the unit does not exist the in database, Step 11. The conversion process is halted and control is transferred to the input box containing the unit that can not be found.

Referring back to Question 12 of FIG. 1, if no partial match was found in either the Units Table or the Derived Table, the method will follow the procedure outlined in the preceding paragraph relating to checking for and removing any Si prefix from the unit. Once again, if the unit does not begin with an SI prefix, the User is prompted that the unit does not exist in the database, Step 11. The conversion process is halted and control is transferred to the input box containing the unit that can not be found. After all StringFromArray and StringToArray units have been verified the StringFromArray and StringToArray will read according to the figure on the following page.

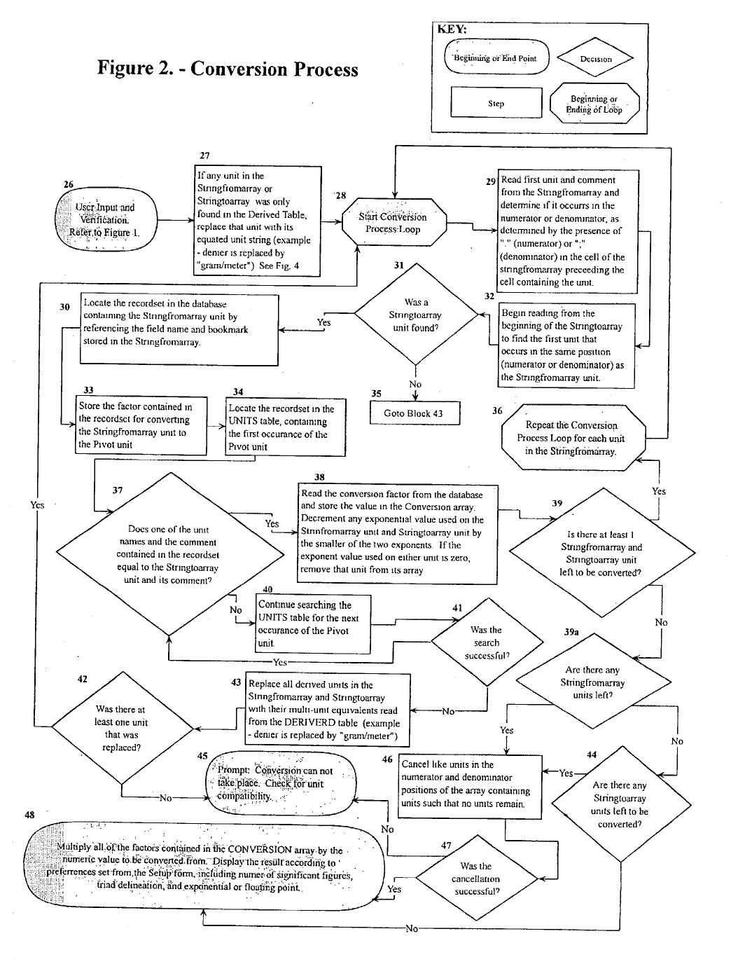

Referring now to FIG. 2, Step 27 allows for the replacement of any unit that was found in the Derived Table with its equated unit string. The method uses the field name in the StringFromArray or StringToArray to determine from which table the unit was found. Referring to FIGS. 3 and 4, if the entry in the Field column is Unit1, Unit2 or Unit3, the unit was found in the Units Table. Conversely, if the Field entry is UnitDer1, UnitDer2 or UnitDer3, the unit was found in the Derived Table. The method then uses

| | Book | | |
|---|---|---|---|
| Comp | Mark | Field | Note |
| StringFromArray | | | |
| : | | | |
| grains | ?/ | Unit3 | English |
| ; | | | |
| hour | ?> | Unit1 | mean solar |
| ; | | | |
| ft | %$ | Unit2 | US survey |
| +2 | | | |
| ; | | | |
| inHg | #$ | Unit2 | 15 deg C. |
| StringToArray | | | |
| : | | | |
| perm | \hat{ }%?/ | Unit1 | 23 deg C. |

the bookmark contained in the StringFromArray or StringToArray to locate the recordset in the Derived Table that contains the unit. The method then replaces the unit in the StringFromArray or StringToArray, wherever it is located, with the unit string entered in the Equated field of the Derived Table, refer to FIG. 4.

Once all units that were found in the Derived Table have been replaced with their equated unit strings, the method begins the process of looping through the StringFromArray and converting each unit encountered with a like unit in the StringToArray. Like units are those units that are from the same category of measure and are located in the same position (numerator or denominator) within the unit string, Steps 28 and 29 of FIG. 2.

Step 32 of FIG. 2 begins the process of looping through the StringToArray to locate a unit that is in the same position as the first unit encountered in the StringFromArray. If such a unit is not found, Step 31, the method will replace all derived units in the StringFromArray and StringToArray with their equated unit string, as indicated by Step 35 and 43. This process is accomplished by locating each unit in the Units Table according to the bookmark information stored in the StringFromArray or StringToArray and then reading the corresponding Pivot unit (refer to FIG. 3) from the Pivot Field in the Units Table. This unit is then searched for in the Derived table. If found, the unit in the StringFromArray or StringToArray is replaced with the equated unit string read from the Equated Field in the Derived Table (refer to FIG. 4). The conversion factors required to convert from the derived unit to the pivot unit and from the pivot unit to the equated units are stored in the Conversion array. Once all derived units in the StringFromArray and StringToArray have been replaced, the conversion process loop begins again as indicated by Beginning of Loop 28 of FIG. 2. If there were no derived units to be replaced, the method will prompt the User that the conversion can not take place and to check for unit compatibility.

Referring again to Step 31, if a StringToArray unit was found that occurs in the same position as the StringFromArray unit, the StringFromArray unit is located in the Units Table by referencing the bookmark value and field name stored in the StringFromArray, Step 30. The method then copies the conversion factor required to convert the StringFromArray unit to the Pivot unit into a temporary variable, Step 33. Step 34 searches the Units Table for the first occurrence of the pivot unit. The method then reads each entry in the Unit1, Unit2 and Unit3 fields contained in the recordset where the Pivot unit was found and compares them to the StringToArray unit. If one of the field entries matches the StringToArray unit, the StringToArray comment is compared to the entry in the Comment field of the recordset, Question 37. If the comments match, then the StringToArray unit that matches the StringFromArray unit has been found. Step 38 records the conversion factor required to convert from the pivot unit to the StringToArray unit. If exponentiation has been applied to either or both StringFromArray and StringToArray units, the exponent value is decreased by the smaller of the two exponents, units without exponents have an implied exponent of one. The conversion factor required to convert the StringFromArray unit to the pivot unit is then combined with the conversion factor required to convert the pivot unit to the StringToArray unit. This combined factor is then raised to the smaller of the two exponential values and stored in the Conversions array. Any successfully converted unit that has a net exponential value of zero is removed from its array and replaced with a single quote, “‘”.

Referring again to Question 37, if none of the fields in the recordset match the StringToArray unit, the method will continue searching the Units Table for the next occurrence of the Pivot unit, Step 40. If no match is found in the Units Table, Question 41, the method will replace all derived units in the StringFromArray and StringToArray with their equated unit string as read from the Derived Table, Step 43. If there was at least one derived unit to be replaced, the method begins the conversion process again Starting with the first StringFromArray unit, Step 42. If there were no derived units to be replaced, the method prompts the User that the conversion can not take place and to check for unit compatibility, End Point 45.

Consider now Question 39 of FIG. 2, if once a StringFromArray unit is successfully converted to a StringToArray unit, the method checks if there are any more StringFromArray units to be converted. If at least one more StringFromArray unit remains, the method checks if there are StringToArray units remaining. If so, the process continues with the next StringFromArray unit as indicated by End of Loop 36. If StringFromArray units remain, but there are no more StringToArray units, Question 39a, the method will cancel StringFromArray units that are from the same category and occur in different positions. For example, a numerator length unit will be cancelled with a denominator length unit, Step 46. Additionally, if there are no more StringFromArray units but StringToArray units remain, the method will cancel StringToArray units, Step 46. In either case, if the cancellation was not successful, the method will, once again, prompt the User that the conversion can not take place and to check for unit compatibility, End Point 45. If the cancellation was successful, Question 47, or if there are no more StringFromArray or StringToArray units to be converted, Questions 39a and 44, all of the factors in the Conversion array are multiplied together and then multiplied by the input numeric value to be converted from. The result is displayed according to the preset display options as previously discussed, End Point 48.

Conclusion, Ramifications and Scope—

Accordingly, the present invention offers a unit conversion method whereby conversions are carried out with minimal effort on the Users part and the source of tabulated units and conversion factors contains fewer entries than most prior art while being able to convert between a far greater number of units and unit combinations. In addition, the method allows preferred versions of multi-version units to be saved and used in conversions automatically, without having to continually interrogate the User for the desired version. The method allows all input to be entered character by character on an alphanumeric keypad thereby allowing users to enter unit names by typing either full spelling or alias names. Consequently, users do not have to be familiar with which category a unit belongs in order to locate it.

While the above description contains many specificities, these should not be construed as limitations on the scope of the invention, but rather as an exemplification of one preferred embodiment thereof. Many other variations are possible. For example, the two tables making up the database of units may be combined. A different number of fields containing the unit name and alias names may be offered. The number of significant digits in any given conversion factor may be determined in code rather than being read from a separate field within the database. Different symbols may be used to distinguish numerator units from denominator units or to specify exponentiation.

Accordingly, the scope of the invention should be determined not merely by the embodiment illustrated, but by the appended claims and their legal equivalents.

What is claimed is:

1. In a calculating device comprised of memory, an alphanumeric keypad and display means, a method for converting units comprising:
(a) storing in memory a first expression comprised of a single numeric value or plurality of numeric values joined by arithmetic symbols, such that said first expression equates to a single numeric value;
(b) storing in memory a first unit part comprised of a single unit or a plurality of units joined by arithmetic symbols; entering said first unit part by spelling full names of said units or alias names of said units using the alphanumeric keypad;
(c) storing in memory a second unit part comprised of a single unit or a plurality of units joined by arithmetic symbols; entering said second unit part by spelling full names of said units or alias names of said units using the alphanumeric keypad;
(d) reading from memory or storage device conversion factors or conversion equations from a conversion table;
(e) segregating said first unit part and said second unit part into individual elements;
(f) converting said first unit part into said second unit part by converting each numerator unit occurring in said first unit part into each, numerator unit occurring in said second unit part and converting each denominator unit occurring in said first unit part into each denominator unit occurring in said second unit part;
(g) replacing any derived unit comprising said first unit part or said second unit part with the derived unit's multi-unit equivalent, said multi-unit equivalent being comprised of other derived units or base units, subsequent reinitiation of conversion process using said multi-unit equivalent in place of said derived unit.

2. The method in claim 1 wherein the conversion of said first unit part into said second unit part continues until either said numerator and denominator units comprising said first unit part have been converted into said numerator and denominator units comprising said second unit part or until each derived unit comprising said first unit part and said second unit part has been replaced with base units such that no derived units comprising said first unit part or said second unit part remain and said conversion of numerator and denominator base units comprising said first unit part and said second unit part is unsuccessful.

3. The method of claim 1 wherein each version of a multi-definition unit comprising said first unit part or said second unit part is displayed for the User's selection of the desired version of said multi-definition unit.

4. The method of claim 1 wherein each said element is comprised of either a unit name, a symbol indicating placement of said unit in numerator or denominator, or a numeric expression representing an exponential value.
